(19) United States
(12) Patent Application Publication
(10) Pub. No.: US 2002/0101185 A1
(43) Pub. Date: Aug. 1, 2002

(54) Discharge lamps

(76) Inventor: Henry Kozlowski, Willowdale (CA)

Correspondence Address: McCormick, Paulding & Huber, City Place II, 185 Asylum Street, Hartford, CT, 06103-3402, US

(21) Appl. No.: 09/977,017

(22) Filed: Oct. 12, 2001

Related U.S. Application Data
(60) Provisional application No. 60/239,839, filed on Oct. 12, 2000.
(60) Provisional application No. 60/301,999, filed on Jun. 29, 2001.

(30) Foreign Application Priority Data
Oct. 12, 2000 (CA) 2,323,299

(51) Int. Cl. H05B 37/02

(52) U.S. Cl. 315/224; 315/225

(57) ABSTRACT

A system for operating a discharge lamp at partial power by heating the filaments to maintain an operating temperature for the filaments within an operating temperature range. The system comprises a ballast with a resonant circuit having a resonant frequency for supplying power to the discharge lamp and a heating power to each filament of the discharge lamp. The heating power is substantially controlled by an inductor in series with each filament. The ballast with the discharge lamp as a load is characterized by an output having a higher voltage at lower power than at higher power levels. This profile is also suitable for heating the filaments of the discharge lamp, which require more heating power or higher voltage when the discharge lamp is operating at lower power levels.

### CROSS-REFERENCE TO RELATED APPLICATIONS

This application is related to and claims priority to U.S. provisional application entitled “WATER TREATMENT ASSEMBLY” having serial No. 60/239,839, by Henry Kozlowski, filed Oct. 12, 2000 and incorporated by reference herein. This application is related to and claims priority to Canadian application entitled “WATER TREATMENT ASSEMBLY” having serial No. 2,323,299, by Henry Kozlowski, filed Oct. 12, 2000 and incorporated by reference herein. This application is related to and claims priority to U.S. provisional application entitled “DISCHARGE LAMPS” having serial No. 60/301,999, by Henry Kozlowski, filed Jun. 29, 2001 and incorporated by reference herein.

### FIELD OF INVENTION

This invention relates to discharge lamps and in particular to an apparatus for operating discharge lamps at partial power.

### BACKGROUND OF THE INVENTION

Discharge lamps and in particular low pressure mercury ultraviolet (UV) discharge lamps typically have an operating temperature range of between about 700° C. to 1000° C. for the lamp filaments, and further, the lamps have a lamp temperature range of about 40° C. to 60° C. at the coldest spot. Typically, the filaments of UV discharge lamps are rated to operate at about 850° C. at full power. If the filaments of a discharge lamp is operated outside of the operating temperature range then the life of the lamp can be greatly reduced. If a discharge lamp is operated at less than full power then the temperature of the filaments may drop outside of the operating temperature range. Another problem with UV discharge lamps is that their UV output level drops as the lamps age with use.

UV discharge lamps are used to generate ultraviolet light to treat water, and wastewater, to effect a disinfection of the water so that the water becomes biologically safe and therefore suitable for drinking or discharge into a lake, river or stream.

UV treatment systems use UV discharge lamps, which are started and powered by ballasts, to produce the UV light. The UV treatment systems for wastewater typically have a plurality of elongated UV discharge lamps arranged in a parallel space-apart relationship and supported by a frame. Racks of UV discharge lamps in a frame are typically placed in a channel through which the water is passed. The lamps are located underwater. Each of the lamps is typically enclosed in a sleeve formed of quartz. Whereas the UV systems for drinking water are usually contained in a pressurized vessel where they are perpendicular or parallel to the flow.

The ability of an UV treatment system to inactivate micro-organisms is a function of the UV fluence generated in the treatment system. The UV fluence is the product of fluence rate and time. The ability of UV light to penetrate water, and hence treat the water, is affected by UV transmission of the water. As the UV light emitted by a lamp decreases, the fluence rate also decreases. Thus, for a particular UV discharge lamp, the important factors in the production of UV light include the age of the lamp, the degree of fouling of the protective quartz sleeve, and the clarity of the water that is being treated.

Conventional UV water treatment systems typically operate the UV discharge lamps at full power and at a predetermined frequency, ranging typically from 20 kHz to 70 kHz. To ensure that water has been treated with sufficient UV fluence, either the flow rate of water per lamp is controlled or greater than required UV light is emitted to compensate for the factors affecting the UV fluence. Neither of these prior art solutions have been satisfactory. The UV discharge lamps are in large banks so control is not very accurate because entire banks of lamps must be turned on and off, and further the emission of UV light at greater levels then necessary is a waste of electrical energy.

The factors affecting UV fluence can be compensated by operating the UV discharge lamps at partial power initially and increasing the power for greater UV light generation as required. However, operating UV discharge lamps at partial power under cooling water may result in the temperature of the filaments dropping below minimum rated operating temperature. Having a separate circuit and logic to maintain the temperature of the filaments is possible, but it adds cost and complexity to such water treatment systems.

A further consideration is preheating of the lamp filaments during the start-up period of UV discharge lamps in order to avoid electrode sputtering effects and thus prolong lamp-operating life. Typically, a preheat transformer is used in preheating and the preheating is shut down once the lamps are operating at full power. Again, such preheating mechanisms increase the cost and complexity of a ballast.

It is therefore desirable to provide an apparatus for operating discharge lamps, which addresses, in part, some of the shortcomings noted above.

### SUMMARY OF THE INVENTION

A system is provided according to the present invention for operating a discharge lamp with lamp filaments at partial power, by heating the filaments to maintain an operating temperature within the operating temperature range. The system comprises a ballast with a resonant circuit having a resonant frequency for supplying power to the discharge lamp and a heating current to each filament of the discharge lamp. The heating current is in the form of alternating current and is substantially controlled by an inductor in series with each filament. The ballast with the discharge lamp as a load is characterized by an output having a higher voltage at low power than at high power levels. This profile is also suitable for heating the filaments of the discharge lamp, which requires more power or higher voltage when the discharge lamp is operating at lower power levels. In this manner, the filaments of the discharge lamp are heated to maintain the proper operating temperature at partial power with minimal additional components.

According to an aspect of the invention, there is provided a ballast module having an output to provide a controllable power for operating a discharge lamp over a partial power range, the discharge lamp having negative resistance characteristics and an operating temperature range, the ballast module comprising: a ballast for converting an electrical energy supply into an alternating voltage for the output; a first inductor to be connected in series to a first filament of the discharge lamp, which forms a first circuit; and a first coupler for coupling the output to the first circuit so that a first heating voltage is applied for heating the first filament; where the first inductor has a first impedance sized for maintaining the first filament within the operating temperature range over the partial power range.

According to another aspect of the invention, there is provided a method of maintaining a discharge lamp within an operating temperature range over a partial power range, the discharge lamp having negative resistance characteristics, the method comprising: receiving electrical energy for powering the discharge lamp; converting the electrical energy to an alternating voltage for an output to supply a power over the partial power range to the discharge lamp; and coupling the output to a first inductor connected in series to a first filament of the discharge lamp so that a first heating voltage is applied for heating the first filament; wherein the first inductor has a first impedance sized for maintaining the first filament within the operating temperature range over the partial power range.

According to another aspect of the invention, there is provided a discharge lamp module for operating over a partial power range by a ballast module having an output with a power, the ballast module comprising a ballast for converting an electrical energy supply into an alternating voltage for the output, and a coupler for coupling the output to supply a heating voltage; the discharge lamp module comprising a discharge lamp having negative resistance characteristics and having a first filament and a second filament with an operating temperature range; and a first circuit comprising a first inductor connected in series to the first filament; wherein the heating voltage is applied to the first circuit for heating the first filament, and wherein the first inductor has a first impedance sized for maintaining the first filament within the operating temperature range over the partial power range.

According to another aspect of the invention, there is provided a method of maintaining filaments of a discharge lamp of a discharge lamp module within an operating temperature range over a partial power range, where a ballast module has an output to supply the discharge lamp with a power over a partial power range, the discharge lamp having negative resistance characteristics, the method comprising: coupling the output to a first inductor connected in series to a first filament of the discharge lamp so that a first heating voltage is applied for heating the first filament wherein the first inductor has a first impedance sized for maintaining the first filament within the operating temperature range over the partial power range.

### BRIEF DESCRIPTION OF THE DRAWINGS

The present invention will be described in detail with reference to the accompanying drawings, in which like numerals denote like parts, and in which:

FIG. 1 is a system architecture diagram of an UV water treatment system in accordance with one embodiment of the invention;

FIG. 2 is a side view of a UV lamp rack of FIG. 1;

FIG. 3 is a block diagram of a ballast module of FIG. 1;

FIG. 4 is a schematic diagram of the ballast module of FIG. 1;

FIG. 5 is a further schematic diagram of the ballast module of FIG. 4;

FIG. 6 is a schematic diagram of elements related to heating of UV discharge lamp filaments of FIG. 5;

FIG. 7 is a schematic diagram of heating circuits to heat the filaments of FIG. 6;

FIG. 8 is a voltage profile of power supplied to the UV discharge lamp of FIG. 7; and

FIG. 9 are voltage versus frequency profiles of output from the ballast module of FIG. 1.

### DETAILED DESCRIPTION OF THE PREFERRED EMBODIMENTS

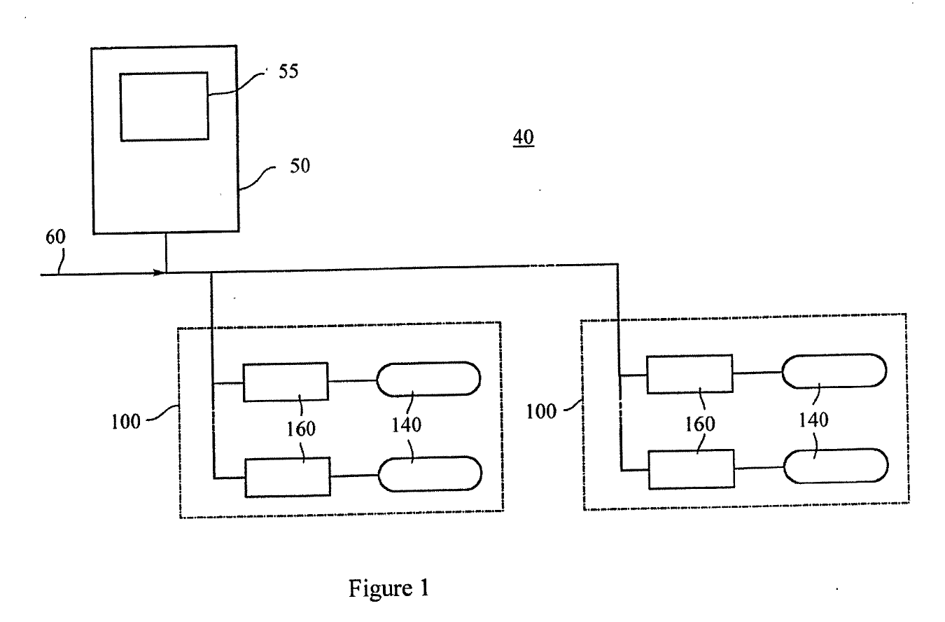

Referring to FIG. 1, there is shown a system architecture diagram of an UV water treatment system 40 in accordance with one embodiment of the invention. The system has an assembly control unit 50 with an operator interface 55. Electrical energy is carried on power lines 60 to modular UV lamp racks 100 for ballast modules 160 to supply appropriate power to UV discharge lamps 140. The operator interface 55 provides the necessary monitoring and control information to an operator to control the system 40.

Communications between assembly control unit 50 and modular UV lamp racks 100 for ballast modules 160 are carried over power lines 60 or alternatively dedicated communication lines may be provided. Typically, assembly control unit 50 is a computer dedicated with appropriate input and output interfaces. Various flow or dose control algorithms and programs are stored within and executed from assembly control unit 50.

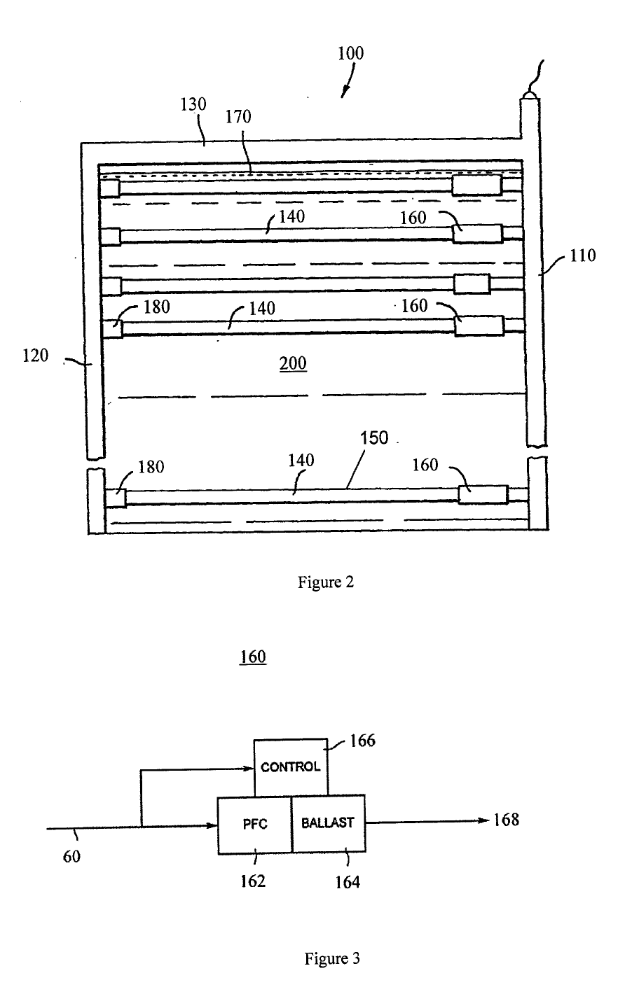

Referring to FIG. 2, there is shown an UV lamp rack 100 in accordance with the embodiment of FIG. 1. The rack 100 has a vertical conduit 110, a vertical support member 120 and a bar 130. Located between vertical conduit 110 and vertical member 120 are a plurality of UV discharge lamps 140 encased in transparent sleeves 150, with associated ballast modules 160 and caps 180. The sleeves 150 are made from a material, which permits passage of UV light. A preferred material is quartz glass. The UV lamps 140 and ballast modules 160 are submerged in liquid 200, e.g. water. The surface of the liquid is shown at 170 being beneath bar 130.

Referring to FIG. 3, a block diagram of the ballast module 160 of FIG. 1 is shown. Electrical energy is supplied to ballast module 160 via power lines 60. The ballast module 160 is composed of three main sections: power factor section 162, ballast 164, and control section 166. Output 168 of electrical energy is applied to the UV discharge lamp 140. The power factor section 162 electrically couples the power lines 60 to the ballast 164 and substantially synchronizes the voltage and current of the electrical energy to the ballast module 160 as viewed by an electrical energy monitor. Power factor circuits are known in the art.

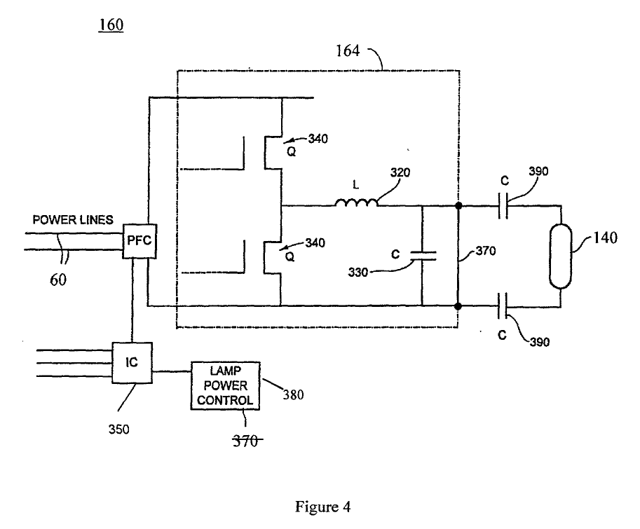

Referring to FIG. 4, a schematic diagram of the ballast module 160 with the ballast 164 for generating the alternating voltage required for the UV discharge lamp 140 of FIG. 3 is shown. The ballast 164 is an electronic type ballast composed of series resonant circuits having an inductor 320 and a capacitor 330 with a resonant frequency of about 135 kHz. The resonant circuit is driven by a driver circuit having two power transistors 340 under the control of integrated circuit (IC) 350. The frequency of the pulses of electrical energy (pulse frequency) provided by the driver circuit to the resonant circuit is determined by lamp power control 380 (as part of the control section 166). The pulse frequency is set to vary from 150 to 200 kHz. The closer the pulse frequency is to the resonant frequency, the greater the power transfer to the resonant circuit and therefore the UV discharge lamp 140. The maximum power transfer for 100% of lamp power is set to occur at a pulse frequency of 150 kHz, and a minimum power transfer of 50% of lamp power is to occur at 200 kHz. Alternately, other power settings may be used as desired.

Referring to FIG. 4, power outlets 370 to UV discharge lamp 140 are isolated from power lines 60 by capacitors 390. The operation of ballast 164 at these high frequencies permits the use of capacitors, instead of relatively large transformers, to provide this additional safety measure.

Referring again to FIG. 3, the control section 166 permits the assembly control unit 50 to control the pulse frequency of the ballast 164 and thereby the power level of the UV discharge lamp 140, and to shut down the UV discharge lamp 140 as desired. The control section 166 further monitors the operating temperature of the ballast module at the hot spots e.g. power transistors 340 in FIG. 4. Beyond a certain set temperature, the control section shuts down the ballast module 160 and signals the assembly control unit 50 that there has been an over-temperature shut down.

The circuits of the ballast module 160 are laid out on a printed circuit board encased in a thermally conductive compound within an outer casing of the ballast module 160. The thermal conductive compound is in contact with the sleeve for an improved thermal path to conduct away-generated heat.

It will be understood by those skilled in the art that the resonant frequency and the range of the pulse frequency may be set higher or lower and that the range of the pulse frequency can be below the resonant frequency instead of above.

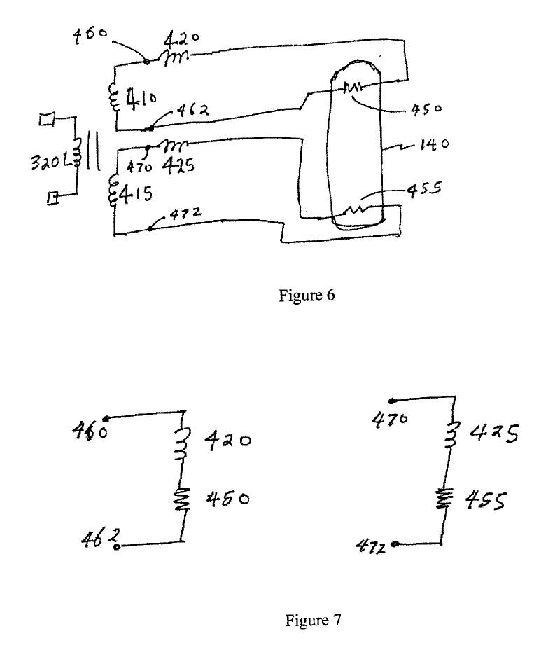

Referring to FIG. 5, a further schematic diagram of the ballast module 160 of FIG. 4 is shown. A block 400 is drawn in FIG. 5, the contents of which has been redrawn in FIG. 6 to better illustrate the elements for heating filaments 450, 455 of the UV discharge lamp 140.

Turning to FIG. 6, a schematic diagram of the elements of the ballast module 160 of FIG. 4 for heating the filaments 450, 455 is shown. The elements comprise a transformer having a primary winding 320 and secondary windings 410, 415; and inductors 420, 425. The primary winding 320 forms the inductance element of the resonant circuit of the ballast 164 and thus the ballast 164 also supplies power to heat the filaments 450, 455 from the secondary windings 410, 415.

Turning to FIG. 7, a schematic diagram of the heating circuits to heat each of the filaments 450, 455. As viewed from the ballast 164, the filament 450 is in series with an inductor 420 and the filament 455 is in series with an inductor 425. As the ballast 164 is supplying power at frequencies over 100 kHz, the current running through each of these series circuits is almost exclusively dependent on the size of the inductor 420, 425. The resistance of the filaments 450, 455 is minimal. Typically, UV discharge lamps have filament resistances ranging from about 0.6 to 3.0 ohm. Examples of UV discharge lamps from a manufacturer may, for example, have filament resistances of 0.8 ohm plus or minus 20%.

The filaments 450, 455 require more heating power when the UV discharge lamp 140 is running at lower power levels than at higher power levels. Thus, the voltage applied to each of the heating circuits has a profile inverse to the power supplied to the UV discharge lamp 140.

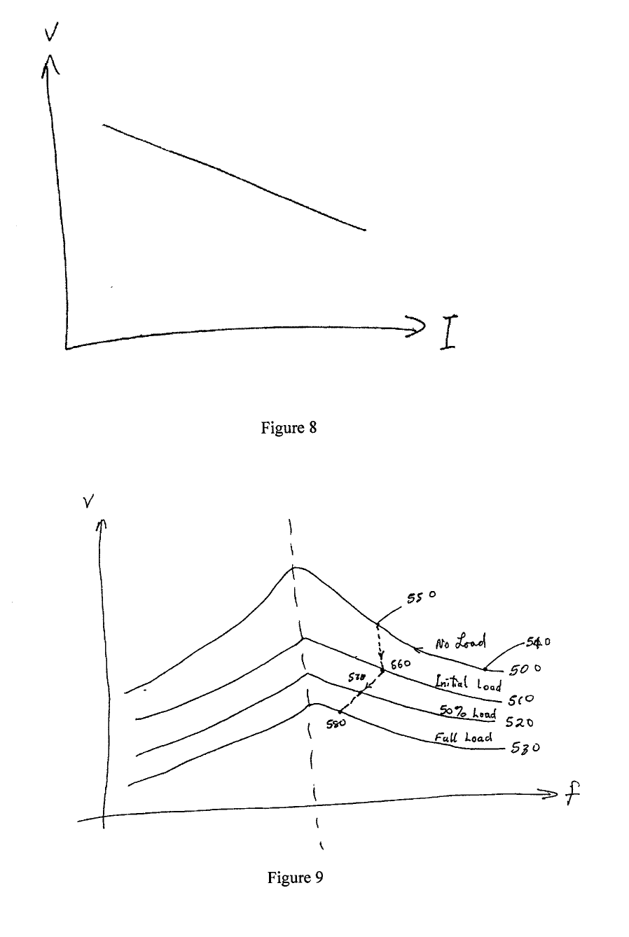

Turning to FIG. 8, a voltage profile of the power supplied by the ballast 164 to the UV discharge lamp 140 is shown. The UV discharge lamp 140, typical of discharge lamps, requires a ballast to limit the power or current otherwise the lamp 140 would burn out. The ballast 164 thus has an output where the voltage profile has a negative slope in that the voltage across the UV discharge lamp 140 decreases as the current, and corresponding power, increases. The UV discharge lamp 140 thus has negative resistance characteristics.

The voltage profile of the output of the ballast 164 thus generally matches the profile needed for heating the filaments 450, 455. This output is accordingly supplied to the heating elements by secondary windings 410, 415. By appropriately choosing the inductance of the inductors 420, 425 to set a heating power profile, the filaments 450, 455 are maintained within the operating temperature range for a range of power levels. For example, without limiting the scope of the invention, the inventor found that choosing an inductance of 10 μH for the inductors 420, 425 using low pressure high output mercury UV discharge lamps, part no. GX074TSL, from Light Sources Inc. for the UV discharge lamps 140 worked to maintain the operating temperature within the operating temperature range from lamp power levels of 100% to about 30%.

Turning to FIG. 9, there is shown voltage versus frequency profiles of the output of the ballast 164 at different loads: no load 500, initial load 510, 50% load 520, and full load 530. There is a spectrum of profiles (not shown) between the no load 500 and the full load 530 profiles. An example, without limiting the scope of the invention, of the operation of ballast 164 is herein described. Initially, the ballast 164 is commanded to start supplying power at a pulse frequency of 200 kHz at point 540 on the no load 500 profile and the pulse frequency is decreased to point 550 where the UV discharge lamp 140 strikes (starts thermionic emission of electrons).

Between point 540 and point 550, the ballast 164 is also supplying power to preheat the filaments 450, 455 to operating temperature before the UV discharge lamp is struck. By varying the speed of the pulse frequency decrease between point 540 and 550, the power to preheat is also controlled for consistent temperature increases to thereby reduce filament fatigue and extend lamp life. Thus, preheating is also provided by the invention without adding further complexity.

When the UV discharge lamp 140 strikes, there is then a load on the ballast 164, which changes the output to the initial load 510 profile and point 560. The ballast 164 supplies more power, and correspondingly sees a greater load, to the UV discharge lamp 140 as the pulse frequency is decreased. The load of the UV discharge lamp 140 on the ballast 164 accordingly changes to, for example, point 570 on the 50% load 520 profile at 50% load and point 580 on the full load 530 profile at full load.

According to the present invention, the impedance of the inductors 420, 425 includes at least one of inductance and resistance. It will be understood by those skilled in the art that the present invention is also operative where the inductors 420, 425 are resistors. The meaning of the term inductor as used herein and in the claims includes resistor.

It will be understood that the present invention is also applicable to systems where a ballast supplies power to more than one discharge lamp instead of a ballast to each UV discharge lamp as described above.

It will be understood that the present invention is also applicable to systems where ballast are remotely located from discharge lamps instead of adjacent or near the discharge lamps as described above.

It will be understood that the present invention is also applicable to various discharge lamps having negative resistance characteristics including low pressure standard output lamps, low pressure high output lamps and low pressure high output amalgam lamps.

It will be understood that the present invention is also applicable to systems, which vary the frequency of pulses below resonant frequency instead of above resonant frequency as described above to operate discharge lamps over partial power ranges.

It will be understood that the present invention is also applicable to systems, which vary the width of the pulses of the pulse frequencies of electronic ballasts to operate discharge lamps over partial power ranges. The width of the pulses of the electronic ballasts is varied to control the power provided by the electronic ballasts to the discharge lamps.

Although preferred embodiments of the invention have been described herein, it will be understood by those skilled in the art that variations may be made thereto without departing from the scope of the invention or the appended claims.

What is claimed is:

1. A ballast module having an output to provide a controllable power for operating a discharge lamp over a partial power range, the discharge lamp having negative resistance characteristics and an operating temperature range, the ballast module comprising:
a ballast for converting an electrical energy supply into an alternating voltage for the output;
a first inductor to be connected in series to a first filament of the discharge lamp, which forms a first circuit; and
a first coupler for coupling the output to the first circuit so that a first heating voltage is applied for heating the first filament;
where the first inductor has a first impedance sized for maintaining the first filament within the operating temperature range over the partial power range.

2. The ballast module of claim 1, further comprising
a second inductor to be connected in series to a second filament of the discharge lamp, which forms a second circuit; and
a second coupler for coupling the output to the second circuit so that a second heating voltage is applied for heating the second filament;
where the second inductor has a second impedance sized for maintaining the second filament within the operating temperature range over the partial power range.

3. The ballast module of claim 1, wherein the ballast comprises a driver circuit for converting the electrical energy supply into pulses having a pulse frequency, and a resonant circuit with a resonant inductance and capacitance, and having a resonance frequency, for converting the pulses to the alternating voltage, where the pulse frequency is varied to control the power of the output.

4. The ballast module of claim 2, wherein the ballast comprises a driver circuit for converting the electrical energy supply into pulses having a pulse frequency, and a resonant circuit with a resonant inductance and capacitance, and having a resonance frequency, for converting the pulses to the alternating voltage, where the pulse frequency is varied to control the power of the output.

5. The ballast module of claim 1, wherein the ballast comprises a driver circuit for converting the electrical energy supply into pulses having a pulse width, and a resonant circuit with a resonant inductance and capacitance for converting the pulses to the alternating voltage, where the pulse width is varied to control the power of the output.

6. The ballast module of claim 2, wherein the ballast comprises a driver circuit for converting the electrical energy supply into pulses having a pulse width, and a resonant circuit with a resonant inductance and capacitance for converting the pulses to the alternating voltage, where the pulse width is varied to control the power of the output.

7. The ballast module of claim 3, wherein the first coupler and the second coupler comprises a transformer having a primary winding forming a part of the resonant inductance, and at least one secondary winding for coupling the output to the first circuit and the second circuit.

8. The ballast module of claim 4, wherein the first coupler and the second coupler comprises a transformer having a primary winding forming a part of the resonant inductance, and at least one secondary winding for coupling the output to the first circuit and the second circuit.

9. The ballast module of claim 5, wherein the first coupler and the second coupler comprises a transformer having a primary winding forming a part of the resonant inductance, and at least one secondary winding for coupling the output to the first circuit and the second circuit.

10. The ballast module of claim 6, wherein the first coupler and the second coupler comprises a transformer having a primary winding forming a part of the resonant inductance, and at least one secondary winding for coupling the output to the first circuit and the second circuit.

11. The ballast module of claim 3, wherein the pulse frequency is varied in a range that is one of above the resonance frequency and below the resonant frequency.

12. The ballast module of claim 4, wherein the pulse frequency is varied in a range that is one of above the resonance frequency and below the resonant frequency.

13. The ballast module of claim 11, wherein the pulse frequency is varied substantially within the range of 150 kHz to 200 kHz and the resonance frequency is set substantially in one of 100 kHz to 150 kHz, and 200 kHz to 250 kHz.

14. The ballast module of claim 12, wherein the pulse frequency is varied substantially within the range of 150 kHz to 200 kHz and the resonance frequency is set substantially in one of 100 kHz to 150 kHz, and 200 kHz to 250 kHz.

15. The ballast module of claim 11, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

16. The ballast module of claim 12, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

17. The ballast module of claim 11, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

18. The ballast module of claim 12, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

19. The ballast module of claim 5, wherein the pulse width is started at a width, which does not strike the discharge lamp, and the pulse width is then increased to strike the discharge lamp where, during this increase, a preheat power is supplied to preheat filaments of the discharge lamp.

20. The ballast module of claim 6, wherein the pulse width is started at a width, which does not strike the discharge lamp, and the pulse width is then increased to strike the discharge lamp where, during this increase, a preheat power is supplied to preheat filaments of the discharge lamp.

21. A method of maintaining a discharge lamp within an operating temperature range over a partial power range, the discharge lamp having negative resistance characteristics, the method comprising:
receiving electrical energy for powering the discharge lamp;
converting the electrical energy to an alternating voltage for an output to supply a power over the partial power range to the discharge lamp; and
coupling the output to a first inductor connected in series to a first filament of the discharge lamp so that a first heating voltage is applied for heating the first filament;
wherein the first inductor has a first impedance sized for maintaining the first filament within the operating temperature range over the partial power range.

22. The method of claim 21, further comprising
coupling the output to a second inductor connected in series to a second filament of the discharge lamp, which forms a second circuit;
wherein the second inductor has a second impedance sized for maintaining the second filament within the operating temperature range over the partial power range.

23. The method of claim 21, wherein a driver circuit converts the electrical energy supply into pulses having a pulse frequency, and a resonant circuit with a resonant inductance and capacitance having a resonance frequency converts the pulses to the alternating voltage, wherein the pulse frequency is varied to control the power of the output.

24. The method of claim 22, wherein a driver circuit converts the electrical energy supply into pulses having a pulse frequency, and a resonant circuit with a resonant inductance and capacitance having a resonance frequency converts the pulses to the alternating voltage, wherein the pulse frequency is varied to control the power of the output.

25. The method of claim 21, wherein a driver circuit converts the electrical energy supply into pulses having a pulse frequency, and a resonant circuit, with a resonant inductance and capacitance, converts the pulses to the alternating voltage, wherein the pulse width is varied to control the power of the output to the discharge lamp.

26. The method of claim 22, wherein a driver circuit converts the electrical energy supply into pulses having a pulse frequency, and a resonant circuit, with a resonant inductance and capacitance, converts the pulses to the alternating voltage, wherein the pulse width is varied to control the power of the output to the discharge lamp.

27. The method of claim 23, wherein a transformer has a primary winding forming a part of the resonant inductance, and at least one secondary winding for coupling the output to the first circuit and the second circuit.

28. The method of claim 24, wherein a transformer has a primary winding forming a part of the resonant inductance, and at least one secondary winding for coupling the output to the first circuit and the second circuit.

29. The method of claim 25, wherein a transformer has a primary winding forming a part of the resonant inductance, and at least one secondary winding for coupling the output to the first circuit and the second circuit.

30. The method of claim 26, wherein a transformer has a primary winding forming a part of the resonant inductance, and at least one secondary winding for coupling the output to the first circuit and the second circuit.

31. The method of claim 23, wherein the pulse frequency is varied in a range that is one of above the resonance frequency and below the resonant frequency.

32. The method of claim 24, wherein the pulse frequency is varied in a range that is one of above the resonance frequency and below the resonant frequency.

33. The method of claim 31, wherein the pulse frequency is varied substantially within the range of 150 kHz to 200 kHz and the resonance frequency is set substantially in one of 100 kHz to 150 kHz, and 200 kHz to 250 kHz.

34. The method of claim 32, wherein the pulse frequency is varied substantially within the range of 150 kHz to 200 kHz and the resonance frequency is set substantially in one of 100 kHz to 150 kHz, and 200 kHz to 250 kHz.

35. The method of claim 31, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

36. The method of claim 32, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

37. The method of claim 31, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

38. The method of claim 32, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

39. The method of claim 25, wherein the pulse width is started at a width, which does not strike the discharge lamp, and the pulse width is then increased to strike the discharge lamp where, during this increase, a preheat power is supplied to preheat filaments of the discharge lamp.

40. The method of claim 26, wherein the pulse width is started at a width, which does not strike the discharge lamp, and the pulse width is then increased to strike the discharge lamp where, during this increase, a preheat power is supplied to preheat filaments of the discharge lamp.

41. A discharge lamp module for operating over a partial power range by a ballast module having an output with a power, the ballast module comprising a ballast for converting an electrical energy supply into an alternating voltage for the output, and a coupler for coupling the output to supply a heating voltage; the discharge lamp module comprising
a discharge lamp having negative resistance characteristics and having a first filament and a second filament with an operating temperature range; and
a first circuit comprising a first inductor connected in series to the first filament;
wherein the heating voltage is applied to the first circuit for heating the first filament, and wherein the first inductor has a first impedance sized for maintaining the first filament within the operating temperature range over the partial power range.

42. The discharge lamp module of claim 41, further comprising
a second circuit comprising a second inductor connected in series to the second filament;
wherein the heating voltage is applied to the second circuit for heating the second filament, and wherein the second inductor has a second impedance sized for maintaining the second filament within the operating temperature range over the partial power range.

43. The discharge lamp module of claim 41, wherein the ballast comprises a driver circuit for converting the electrical energy supply into pulses having a pulse frequency, and a resonant circuit with a resonant inductance and capacitance, and having a resonance frequency, for converting the pulses to the alternating voltage, where the pulse frequency is varied to control the power of the output.

44. The discharge lamp module of claim 42, wherein the ballast comprises a driver circuit for converting the electrical energy supply into pulses having a pulse frequency, and a resonant circuit with a resonant inductance and capacitance, and having a resonance frequency, for converting the pulses to the alternating voltage, where the pulse frequency is varied to control the power of the output.

45. The discharge lamp module of claim 41, wherein the ballast comprises a driver circuit for converting the electrical energy supply into pulses having a pulse width, and a resonant circuit with a resonant inductance and capacitance for converting the pulses to the alternating voltage, where the pulse width is varied to control the power of the output.

46. The discharge lamp module of claim 42, wherein the ballast comprises a driver circuit for converting the electrical energy supply into pulses having a pulse width, and a resonant circuit with a resonant inductance and capacitance for converting the pulses to the alternating voltage, where the pulse width is varied to control the power of the output.

47. The discharge lamp module of claim 43, wherein the coupler comprises a transformer having a primary winding forming a part of the resonant inductance, and at least one secondary winding for coupling the output to the first circuit and the second circuit.

48. The discharge lamp module of claim 44, wherein the coupler comprises a transformer having a primary winding forming a part of the resonant inductance, and at least one secondary winding for coupling the output to the first circuit and the second circuit.

49. The discharge lamp module of claim 45, wherein the coupler comprises a transformer having a primary winding forming a part of the resonant inductance, and at least one secondary winding for coupling the output to the first circuit and the second circuit.

50. The discharge lamp module of claim 46, wherein the coupler comprises a transformer having a primary winding forming a part of the resonant inductance, and at least one secondary winding for coupling the output to the first circuit and the second circuit.

51. The discharge lamp module of claim 43, wherein the pulse frequency is varied in a range that is one of above the resonance frequency and below the resonant frequency.

52. The discharge lamp module of claim 44, wherein the pulse frequency is varied in a range that is one of above the resonance frequency and below the resonant frequency.

53. The discharge lamp module of claim 51, wherein the pulse frequency is varied substantially within the range of 150 kHz to 200 kHz and the resonance frequency is set substantially in one of 100 kHz to 150 kHz, and 200 kHz to 250 kHz.

54. The discharge lamp module of claim 52, wherein the pulse frequency is varied substantially within the range of 150 kHz to 200 kHz and the resonance frequency is set substantially in one of 100 kHz to 150 kHz, and 200 kHz to 250 kHz.

55. The discharge lamp module of claim 51, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

56. The discharge lamp module of claim 52, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

57. The discharge lamp module of claim 51, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

58. The discharge lamp module of claim 52, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

59. The discharge lamp module of claim 25, wherein the pulse width is started at a width, which does not strike the discharge lamp, and the pulse width is then increased to strike the discharge lamp where, during this increase, a preheat power is supplied to preheat filaments of the discharge lamp.

60. The discharge lamp module of claim 26, wherein the pulse width is started at a width, which does not strike the discharge lamp, and the pulse width is then increased to strike the discharge lamp where, during this increase, a preheat power is supplied to preheat filaments of the discharge lamp.

61. A method of maintaining filaments of a discharge lamp of a discharge lamp module within an operating temperature range over a partial power range, where a ballast module has an output to supply the discharge lamp with a power over a partial power range, the discharge lamp having negative resistance characteristics, the method comprising:
coupling the output to a first inductor connected in series to a first filament of the discharge lamp so that a first heating voltage is applied for heating the first filament wherein the first inductor has a first impedance sized for maintaining the first filament within the operating temperature range over the partial power range

62. The method of claim 61, further comprising
coupling the output to a second inductor connected in series to a second filament of the discharge lamp so that a second heating voltage is applied for heating the second filament wherein the second inductor has a second impedance sized for maintaining the second filament within the operating temperature range over the partial power range

63. The method of claim 61, wherein the ballast module comprises a driver circuit for converting the electrical energy supply into pulses having a pulse frequency, and a resonant circuit with a resonant inductance and capacitance, and having a resonance frequency, for converting the pulses to the output, where the pulse frequency is varied to control the power of the output.

64. The method of claim 62, wherein the ballast module comprises a driver circuit for converting the electrical energy supply into pulses having a pulse frequency, and a resonant circuit with a resonant inductance and capacitance, and having a resonance frequency, for converting the pulses to the output, where the pulse frequency is varied to control the power of the output.

65. The method of claim 61, wherein the ballast module comprises a driver circuit for converting the electrical energy supply into pulses having a pulse width, and a resonant circuit with a resonant inductance and capacitance for converting the pulses to the output, where the pulse width is varied to control the power of the output.

66. The method of claim 62, wherein the ballast module comprises a driver circuit for converting the electrical energy supply into pulses having a pulse width, and a resonant circuit with a resonant inductance and capacitance for converting the pulses to the output, where the pulse width is varied to control the power of the output.

67. The method of claim 63, wherein a transformer having a primary winding forming a part of the resonant inductance, and at least one secondary winding for coupling the output to the first inductor connected in series to the first filament and the second inductor connected in series to the second filament.

68. The method of claim 64, wherein a transformer having a primary winding forming a part of the resonant inductance, and at least one secondary winding for coupling the output to the first inductor connected in series to the first filament and the second inductor connected in series to the second filament.

69. The method of claim 65, wherein a transformer having a primary winding forming a part of the resonant inductance, and at least one secondary winding for coupling the output to the first inductor connected in series to the first filament and the second inductor connected in series to the second filament.

70. The method of claim 66, wherein a transformer having a primary winding forming a part of the resonant inductance, and at least one secondary winding for coupling the output to the first inductor connected in series to the first filament and the second inductor connected in series to the second filament.

71. The method of claim 63, wherein the pulse frequency is varied in a range that is one of above the resonance frequency and below the resonant frequency.

72. The method of claim 64, wherein the pulse frequency is varied in a range that is one of above the resonance frequency and below the resonant frequency.

73. The method of claim 71, wherein the pulse frequency is varied substantially within the range of 150 kHz to 200 kHz and the resonance frequency is set substantially in one of 100 kHz to 150 kHz, and 200 kHz to 250 kHz.

74. The method of claim 72, wherein the pulse frequency is varied substantially within the range of 150 kHz to 200 kHz and the resonance frequency is set substantially in one of 100 kHz to 150 kHz, and 200 kHz to 250 kHz.

75. The method of claim 71, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

76. The method of claim 72, wherein the pulse frequency is varied in the range above the resonance frequency, and wherein the pulse frequency is started at a frequency, which does not strike the discharge lamp, and the pulse frequency is then decreased to strike the discharge lamp where, during this decrease, a preheat power is supplied to preheat filaments of the discharge lamp.

77. The method of claim 71, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

78. The method of claim 72, wherein the pulse frequency is varied in the range below the resonance frequency, and wherein the pulse frequency is started at a frequency, which does not strike the discharge lamp, and the pulse frequency is then increased to strike the discharge lamp where, during this increase, a preheat power is supplied to preheat filaments of the discharge lamp.

79. The method of claim 65, wherein the pulse width is started at a width, which does not strike the discharge lamp, and the pulse width is then increased to strike the discharge lamp where, during this increase, a preheat power is supplied to preheat filaments of the discharge lamp.

80. The method of claim 66, wherein the pulse width is started at a width, which does not strike the discharge lamp, and the pulse width is then increased to strike the discharge lamp where, during this increase, a preheat power is supplied to preheat filaments of the discharge lamp.
